(19) United States
(12) Patent Application Publication
(10) Pub. No.: US 2015/0013222 A1
(43) Pub. Date: Jan. 15, 2015

(54) PLANT POT

(71) Applicant: SWEEOO (SHENZHEN) TRADING CO., LTD., Shenzhen City (CN)

(72) Inventors: Chih Hui Su, Shenzhen City (CN); Tien Yin Chan, Shenzhen City (CN)

(73) Assignee: SWEEOO (SHENZHEN) TRADING CO., LTD., Shenzhen City (CN)

(21) Appl. No.: 14/271,887

(22) Filed: May 7, 2014

(30) Foreign Application Priority Data
Jul. 10, 2013 (CN) 2013204095035

(51) Int. Cl. A01G 9/02

(52) U.S. Cl. CPC A01G 9/028
USPC 47/65.5

(57) ABSTRACT

The present invention relates to the field of household items and provides a plant pot which includes a pot body and a base, wherein the pot body has a wall with a porous structure, the pot body is in good engagement with the base, the pot body includes a first compartment, the base includes a second compartment, and the first compartment extends into the second compartment. The pot body of the plant pot is in good engagement with the base, such that no gap exists between the base and the pot body, thereby preventing insects from entering the base allowing the liquid in the plant pot to be more clean and sanitary. Moreover, the base of the present invention can contain more liquid, and liquid in the second compartment may penetrate through the porous body so as to be absorbed by the root system of the plant in the compartment, thereby ensuring a long-term and normal supply of liquid to the plant.

### RELATED APPLICATION DATA

The instant application claims priority to Chinese Application No.: 201320409503.5 entitled PLANT POT filed on Jul. 10, 2013, the subject matter of which is incorporated herein in its entirety.

### FIELD OF THE INVENTION

The present invention relates to the field of household items, and more particularly to a plant pot.

### BACKGROUND OF THE INVENTION

With the development of garden technology and reduction of afforestation of city, more and more people start to plant a variety of plants in plant pots, which may not only beautify the environment, but also purify the air.

In the prior art, as shown in FIG. 1, a plant pot includes a base 02 and a pot body 01 provided on the base 02. When pouring a liquid, the liquid is poured from an upper mouth of the pot body 01, and excess liquid will penetrate to the base 02. One problem with the technical scheme is that if the base 02 is too deep (being relatively tall in height), there will be too much fluid in the base 02, and if placed for a longer time, various insects will be attracted here, which is very unsanitary. But if the base 02 is too shallow, the liquid evaporates quickly, such that while a person is out, a normal supply of liquid to the plants cannot be assured, thereby adversely affecting the growth or survival of plants.

Therefore, there is a need for such a plant pot which not only is clean and sanitary, but also provides the plants with fluid for a long time.

### SUMMARY

The present invention aims to provide a plant pot to solve the problem in the prior art that the existing plant pot cannot provide a normal supply of fluid to the plants, and the accumulation of fluid leads to unsanitary conditions, etc.

For the purposes of the present invention, a plant pot is provided, which includes a base and a pot body with a wall having a porous structure, wherein the pot body is in good engagement with the base which includes a first compartment, the base includes a second compartment, and the first compartment extends into the second compartment.

Preferably, the base includes a transparent or semitransparent wall.

Preferably, the pot body further includes a porous body, wherein the top of the porous body is in communication with the bottom of the first compartment.

Preferably, the wall of the porous body is provided with through holes for communication between the second compartment and the porous body.

In any of the above-mentioned technical schemes, the pot body and the base are externally provided with a water-resisting layer respectively.

In the above-mentioned technical schemes of the present invention, the pot body is in good engagement with the base, such that no gap exists between the base and the pot body, thereby preventing insects from entering the base and allowing the liquid in the plant pot to be more clean and sanitary. Moreover, the base of the present invention may contain more liquid, and liquid in the second compartment may penetrate through the pot body so as to be absorbed by root system of the plant, thereby ensuring a long-term and normal supply of liquid to the plant.

### BRIEF DESCRIPTION OF DRAWINGS

FIG. 1 is a schematic view of the structure of the plant pot in the prior art;

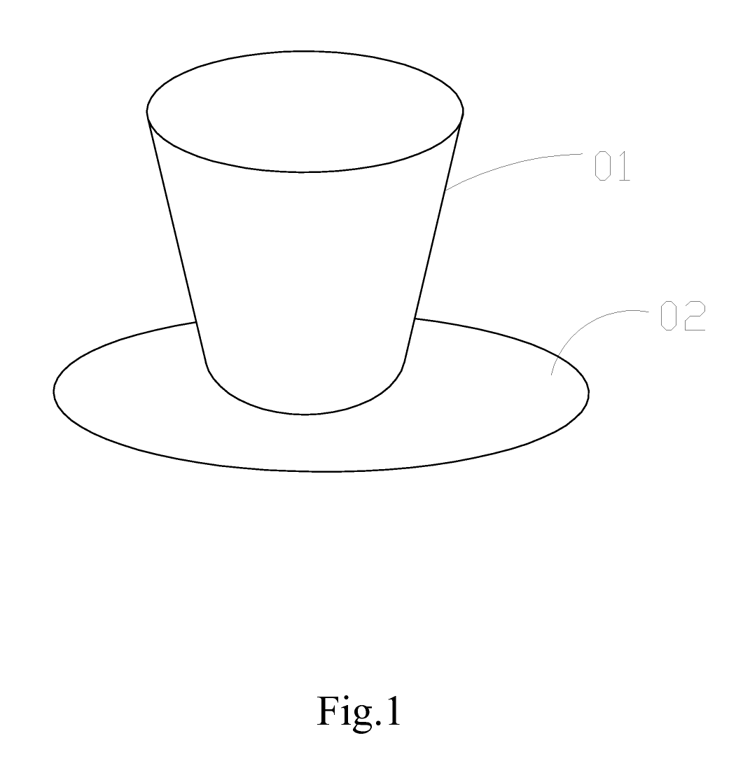

FIG. 2 is a schematic cross-section view of the plant pot provided in one embodiment of the present invention;

FIG. 3 is a schematic view of the structure of the plant pot provided in one embodiment of the present invention;

FIG. 4 is a schematic cross-section view of the plant pot provided in one embodiment of the present invention.

### DETAILED DESCRIPTION OF THE EMBODIMENTS

The objects, technical schemes and advantages will become more readily apparent upon reference to the following descriptions when taken in conjunction with the appended drawings.

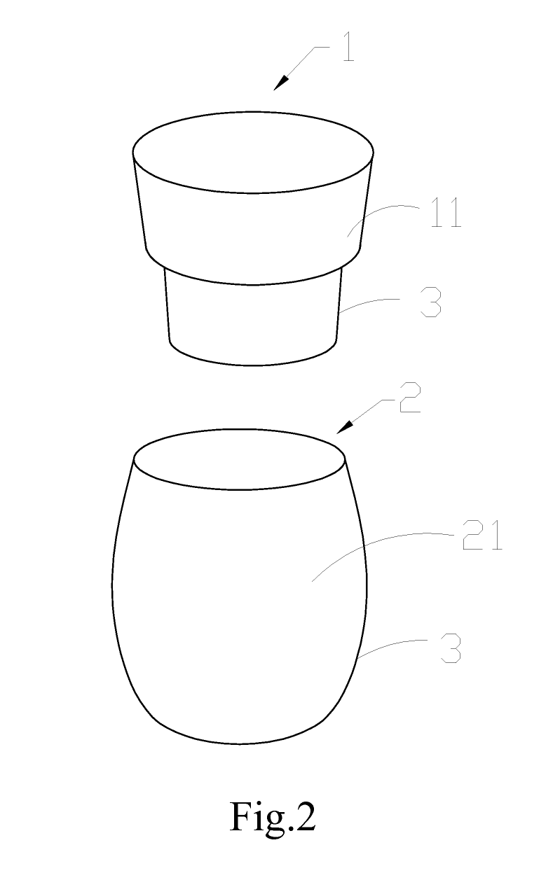

With reference to FIGS. 2, 3 and 4, the present invention provides some embodiments. A plant pot according to the application includes a pot body 1 and a base 2 characterized as follows.

Firstly, the base 2 includes a wall which may be completely opaque, such as a wall made of ceramic material, or transparent or semitransparent, and the invention has no limitation thereon.

Preferably, the wall of the base 2 is transparent or semitransparent to allow a convenient viewing of the liquid within the base 2, and thus help a user to know when to water the plants. The transparent or semitransparent material may be, but not limited to, acrylic plate, PE (polyethylene), PV (polyvinyl), PC (polycarbonate), PVC (polyvinyl chloride) and liquid crystal. Preferably, the base 2 may also be partially transparent or semitransparent, while the rest part is opaque. The base 2 may also be totally transparent or opaque.

The base 2 may include a second compartment 21 with the pot body 1 extending thereinto. There is no particular limit to the shape of the base 2, which can be square, oval or other irregular shapes.

Secondly, the pot body 1 is in good engagement with the base 2, such that liquid in the base 2 can be prevented from evaporating too fast, thereby being kept for a long time. The pot body 1 may include a first compartment 11, and may further include a wall 121 having a porous structure. Preferably, the side wall and/or bottom of the first compartment 11 is formed as a wall 121 having a porous structure. Otherwise, the bottom of the first compartment 11 is in communication with the second compartment 21, and the wall of the first compartment 11 is a wall 121 having no porous structure. The technical scheme may allow liquid in the base to enter the pot body 1 through the porous structure.

The pot body 1 may also include a porous body 12, wherein the lower part of the first compartment 11 is in communication with the upper part of the porous body 12. There is no particular limit to the shape of the first compartment 11, which can be multi-stepped with the upper mouth of each step being of a square, round or other irregular shapes.

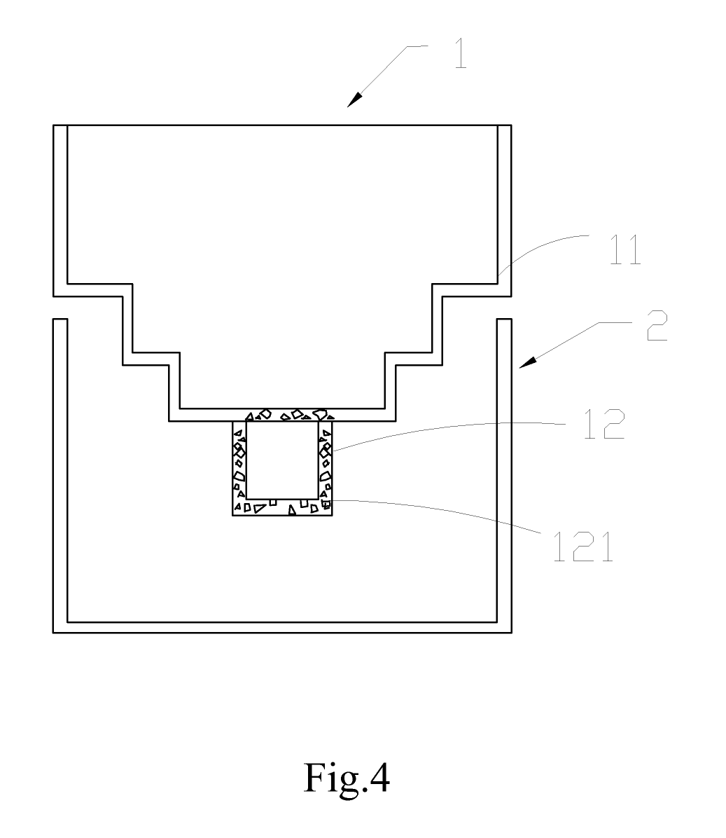

In this embodiment, as shown in FIG. 4, the porous body 12 includes the wall 121 having the porous structure which may allow the liquid in the second compartment 21 to penetrate into the porous body 12 so as to effectively prevent rotting of the root system of the plants resulted from too much liquid.

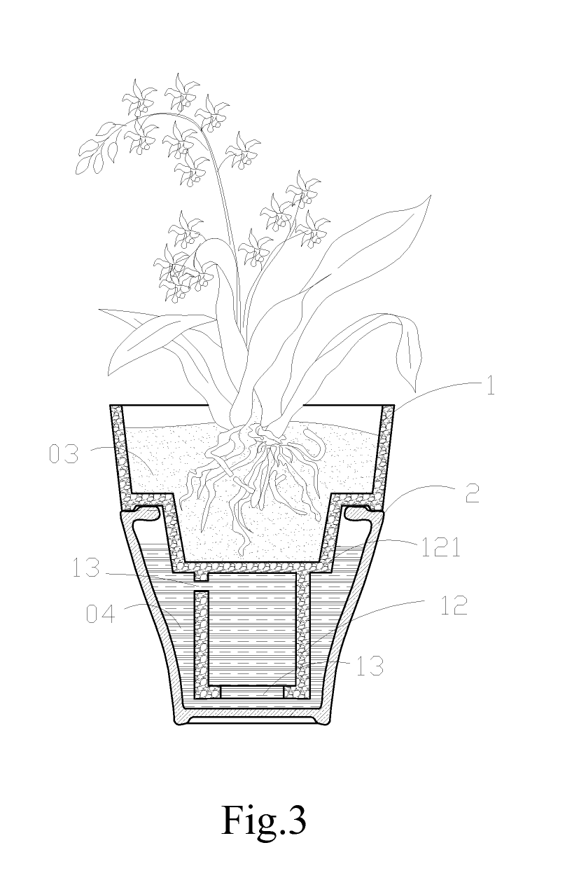

As shown in FIG. 3, the wall of the porous body 12 is provided with one or more through holes 13 which are used for communication between the second compartment 21 and the porous body 12. This technical scheme may allow a quick entering of the liquid in the second compartment into the porous body.

In the above-mentioned technical schemes, the pot body 1 and the base 2 are respectively provided with a water-resisting layer 3 (as shown in FIG. 2) which can prevent the liquid in the pot body 1 and the base 2 from exuding, that is, prevent the liquid from evaporating. There is no particular limit to the water-resisting layer 3, as long as a penetration of the liquid can be prevented, it may be, for example, a glaze layer.

In this embodiment, the pot body 1 is in good engagement with the base 2, such that no gap exists between the base 2 and the pot body 1, thereby preventing insects from entering the base 2 allowing the liquid in the plant pot to keep sanitary. Moreover, the base 2 of the present invention can contain more liquid, and liquid in the second compartment 21 may penetrate through the porous body 12 so as to be absorbed by the root system of the plant, thereby ensuring a long-term and normal supply of liquid to the plant.

The usage of the plant pot will be described below with reference to FIGS. 2, 3 and 4. The first compartment 11 is used to plant the plants and store soil 03 and so on. When the plants need liquid, the pot body 1 may be removed followed by a pouring of liquid 04 into the base 2, and then the pot body 1 is placed on the base 2 again. The pot body 1 and the base 2 are in good engagement, such that the liquid in the base 2 does not evaporate quickly due to exposure to air, and thus can be kept for a long time. Besides, insects can be prevented from entering the base 2 that allows the liquid to be more clean and sanitary. The porous body 12 is provided with the wall 121 having the porous structure, through which the liquid may penetrate into the porous body 12 slowly. The communication part between the top of the porous body 12 and the compartment 11 may also be the wall 121 having the porous structure, and the liquid may also go into the first compartment 11 through the communication part (that means, there is an opening in the top of the porous body 12) between the top of the porous body 12 and the compartment 11, thereby ensuring a sufficient liquid absorption of the plant without submerging the root system due to too much liquid.

It should be noted that the typical application of the present invention is not limited to the plant pot itself, and other articles of daily use in the art may also employ the structure discussed in the present invention.

The present invention has been described with reference to preferred embodiments which are not intended to limit the invention, and any modification, substitution, equivalent and the like made within the spirit and principle of the invention should fall in the protection scope thereof.

What is claimed is:

1. A plant pot, characterized by comprising a base and a pot body with a wall having a porous structure, wherein the pot body is in good engagement with the base, the pot body includes a first compartment, the base includes a second compartment, and the first compartment extends into the second compartment.

2. The plant pot according to claim 1, characterized in that the base includes a transparent or semitransparent wall.

3. The plant pot according to claim 1, characterized in that the pot body further includes a porous body, and an upper part of the porous body is in communication with a lower part of the first compartment.

4. The plant pot according to claim 1, characterized in that the wall of the porous body is provided with through holes for communication between the second compartment and the porous body.

5. The plant pot according to any one of claim 1 to 4, characterized in that the pot body and the base are externally provided with a water-resisting layer respectively.
